(19) United States
(12) Patent Application Publication
(10) Pub. No.: US 2014/0199482 A1
(43) Pub. Date: Jul. 17, 2014

(54) CEMENT AND SKINNING MATERIAL FOR CERAMIC HONEYCOMB STRUCTURES

(71) Applicant: Dow Global Technologies LLC, Midland, MI (US)

(72) Inventors: Jun Cai, Midland, MI (US); Chan Han, Midland, MI (US); Michael T. Malanga, Midland, MI (US); Ashish Kotnis, Troy, MI (US)

(21) Appl. No.: 14/236,141

(22) PCT Filed: Sep. 20, 2012
(86) PCT No.: PCT/US12/56233

§ 371 Date: Jan. 30, 2014

Related U.S. Application Data
(60) Provisional application No. 61/539,519, filed on Sep. 27, 2011.

(51) Int. Cl. C04B 38/00; C04B 33/32

(52) U.S. Cl. CPC C04B 38/0006; C04B 33/32
USPC 427/243

(57) ABSTRACT

Skins and/or adhesive layers are formed on a porous ceramic honeycomb by applying a layer of a cement composition to a surface of the honeycomb and firing the cement composition. The cement composition contains inorganic filler particles, a carrier fluid and a clay material rather than the colloidal alumina and/or silica materials that are conventionally used in such cements. The cement compositions resist permeation into the porous walls of the ceramic honeycomb. As a result, lower temperature gradients are seen in the honeycomb structure during rapid temperature changes, which results in an increased thermal shock resistance.

The present invention relates to cement and skinning materials for ceramic filters, as well as to methods for applying skins to ceramic filters and to methods for assembling segmented ceramic filters.

Ceramic honeycomb-shaped structures are widely used in applications such as emission control devices, especially in vehicles that have internal combustion engines. These structures also are used as catalyst supports. The honeycomb structures contain many axial cells that extend the length of the structure from an inlet end to an outlet end. The cells are defined and separated by porous walls that also extend along the longitudinal length of the structure. Individual cells are capped off at the inlet end or the outlet end to form outlet or inlet cells, respectively. Inlet cells are at least partially surrounded by outlet cells, and vice versa, usually by arranging the inlet and outlet cells in an alternating pattern. During operation, a gas stream enters the inlet cells, passes through the porous walls and into the outlet cells, and is discharged from the outlet end of the outlet cells. Particulate matter and aerosol droplets are captured by the walls as the gas stream passes through them.

These honeycomb structures often experience large changes in temperature as they are used. One specific application, diesel particulate filters, is illustrative. Ceramic honeycomb structures that are used as diesel particulate filters will experience temperatures that can range from as low as −40° C. to several hundred ° C. during the normal operation of the vehicle. In addition, these diesel particulate filters are periodically exposed to even higher temperatures during a “burn-out” or regeneration cycle, when trapped organic soot particles are removed via high temperature oxidation. The thermal expansion and contraction that accompany these temperature changes create significant mechanical stresses within the honeycomb structures. The parts often exhibit mechanical failure as a result of these stresses. The problem is especially acute during “thermal shock” events, when large and rapid temperature changes create large temperature gradients within the honeycomb structure. Therefore, the ceramic honeycomb structures for use in these applications are designed to provide good thermal shock resistance.

On of the ways of improving thermal shock resistance in a ceramic honeycomb is to segment it. Instead of forming the entire honeycomb structure from a single, monolithic body, a number of smaller honeycombs are made separately, and then assembled into a larger structure. An inorganic cement is used to bond the smaller honeycombs together. The inorganic cement is in general more elastic than are the honeycomb structures. It is this greater elasticity that allows thermally-induced stresses to dissipate through the structure, reducing high localized stresses that can cause cracks to form. Examples of the segmenting approach are seen in U.S. Pat. No. 7,112,233, U.S. Pat. No. 7,384,441, U.S. Pat. No. 7,488,412, and U.S. Pat. No. 7,666,240.

The segmenting approach is helpful but presents its own problems. The inorganic cement material tends to penetrate into the cell walls that are adjacent to the cement layer. The cement in many cases even permeates through those walls into the peripheral cells of each segment, narrowing or even blocking these cells. This permeation has several adverse effects. The peripheral walls become denser because the pores become filled with cement. These denser walls act as heat sinks; they change temperature more slowly than other portions of the structure, and for that reason temperature gradients form. In addition, less gas can flow through cells that become narrowed or blocked due to the permeation of the cement into them; this too leads to higher temperature gradients within the structure. These temperature gradients promote cracking and failure.

It is also common to apply a skin layer to the periphery of the honeycomb structure, whether or not it is otherwise segmented, to form a peripheral skin. This skin material is an inorganic cement, much like that used to bind a segmented honeycomb together. It can permeate into the peripheral walls and cells of the honeycomb, and when it does so, it causes higher temperature gradients much like the cement layers within a segmented honeycomb do. These higher temperature gradients reduce the thermal shock resistance of the honeycomb.

One way to ameliorate these problems is to coat the honeycomb with a barrier coating (such as an organic polymer layer, which burns off during the firing step). Another way is to increase the viscosity of the cement composition. Each approach has the disadvantages, such as adding processing steps (and associated costs), increasing the drying time needed to cure the cement, and causing cracking and defects in the cement layer.

It would be desirable to provide a method for producing ceramic honeycombs having good thermal shock resistance. In particular, it would be desirable to provide an inorganic cement and skinning material that does not readily permeate into the walls of a ceramic honeycomb.

This invention is a method of forming a honeycomb structure comprising forming a layer of an uncured inorganic cement composition on at least one surface of a ceramic honeycomb having porous walls and then firing the uncured inorganic cement composition and the ceramic honeycomb to form a cured cement layer on said at least one surface of the ceramic honeycomb,

wherein the uncured inorganic cement composition contains at least one inorganic filler, at least one carrier fluid and an inorganic binder, and further wherein at least 75% by weight of the inorganic binder is a clay mineral and wherein colloidal alumina and colloidal silica together constitute from 0 to 25% of the weight of the inorganic binder.

The cured cement layer may form an adhesive layer between segments of a segmented honeycomb structure, a skin layer or both.

Cement compositions that are based on clay minerals rather than colloidal alumina and/or colloidal silica have been found to permeate less into the porous walls of the ceramic honeycomb than do colloidal alumina and silica particles. This is unexpected, as the particle size of the clay minerals is generally much smaller than the pores in the honeycomb walls and when in the presence of a liquid carrier would therefore be expected to be drawn into the pores due to capillary action. As a result of the reduced permeation of the binder, less of the cement composition penetrates into the walls and into adjoining cells and thermal gradients associated with the penetration of the cement composition are reduced. This leads to greater thermal shock resistance than when the colloidal materials form the binder.

By “clay mineral”, it is meant an amphoteric aluminum silicate, which may contain iron, alkali metals, alkaline earth metals and small amounts of other metals, having a layered structure and primary particle size of less than 5 μm, and which upon firing forms a ceramic that may be amorphous or fully or partially crystalline. Examples of suitable clay minerals include those of the kaolin-serpentine group, such as kaolinite, dickite, nacrite, halloysite, chrysotile, antigorite, lizaradite and greenalite; clay minerals of the pyrophyllite-talc group such as pyrophyllite, talc, and ferripyrophyllite; clay minerals of the mica mineral group, such as muscovite, phlogopite, biotite, celadonite, glauconite and illite; clay minerals of the vermiculite group; clay minerals of the smectic group; clay minerals of the chlorite group, such as clinochlore, chamosite, pennantite, nimite, cookeite; interstratified clay minerals such as rectorite, tosudite, corrensite, hydrobiotite, aliettite and kulkeite; imogolite and allophane.

The clay mineral is conveniently provided in the form of a natural clay that includes, in addition to the clay mineral, mineral particles such as quartz particles or other crystalline particles. Natural clays such as kaolin and ball clay are useful binders for use in this invention.

It is preferred that colloidal alumina and colloidal silica together constitute no more than 10%, more preferably no more 2% of the weight of the inorganic binder. The binder may be devoid of colloidal alumina and colloidal silica.

The cement composition contains inorganic filler particles. These inorganic filler particles are neither clay minerals nor colloidal alumina or colloidal silica and do not form a binding phase when the cement composition is fired. The inorganic filler particles may be amorphous or crystalline or partly amorphous and partly crystalline. Examples of inorganic filler particles include, for example, alumina, silicon carbide, silicon nitride, mullite, cordierite, aluminum titanate, amorphous silicates or aluminosilicates, partially crystallized silicates or aluminosilicates, and the like. Aluminosilicates may contain other elements such as rare earths, zirconium, alkaline earths, iron and the like; these may constitute as much as 40 mole % of the metal ions in the material.

Some or all of the inorganic filler particles may be components of a natural clay material, such as quartz particles as are typically present in natural kaolin and other clays.

The inorganic filler particles may be selected to have very nearly the same CTE (i.e., within about 1 ppm/° C. in the temperature range from 100-600° C.) as the honeycomb material, after the firing step is completed. The comparison is performed on the basis of the fired cement to account for changes in CTE that may occur to the fibers and/or other particles during the firing step, due to, for example, changes in crystallinity and/or composition that may occur.

The inorganic filler particles may be present in the form of low aspect ratio (i.e., less than 10) particles, in the form of fibers (i.e., particles having an aspect ratio of 10 or greater), in the form of platelets, or in some combination of low aspect ratio particles, fibers and platelets. Low aspect ratio particles preferably have a longest dimension of up to about 500 μm, preferably up to 100 μm. Fibers may have lengths of from 10 micrometers up to 100 millimeters. In some embodiments, fibers have lengths of from 10 micrometers to 1000 microns. In other embodiments, a mixture is used, which includes short fibers having a length from 10 micrometers to 1000 micrometers and longer fibers having lengths of greater than 1 millimeter, preferably from greater than 1 to 100 millimeters. Fiber diameters may be from about 0.1 micrometer to about 20 micrometers.

The cement composition also includes a carrier fluid. The carrier liquid may be, for example, water or any organic liquid. Suitable organic liquids include alcohols, glycols, ketones, ethers, aldehydes, esters, carboxylic acids, carboxylic acid chlorides, amides, amines, nitriles, nitro compounds, sulfides, sulfoxides, sulfones, and the like. Hydrocarbons, including aliphatic, unsaturated aliphatic (including alkenes and alkynes) and/or aromatic hydrocarbons, are useful carriers. Organometallic compounds are also useful carriers. Preferably, the carrier fluid is water, an alkane, an alkene or an alcohol. More preferably, the liquid is an alcohol, water or combination thereof. When an alcohol is used it is preferably methanol, propanol, ethanol or combinations thereof. Most preferably, the carrier fluid is water.

The cement composition may contain other useful components, such as those known in the art of making ceramic cements. Examples of other useful components include dispersants, deflocculants, flocculants, plasticizers, defoamers, lubricants and preservatives, such as those described in Chapters 10-12 of Introduction to the Principles of Ceramic Processing, J. Reed, John Wiley and Sons, N.Y., 1988. When an organic plasticizer is used, it desirably is a polyethylene glycol, fatty acid, fatty acid ester or combination thereof.

The cement composition may also contain one or more binders. Examples of binders include cellulose ethers such as those described in Chapter 11 of Introduction to the Principles of Ceramic Processing, J. Reed, John Wiley and Sons, New York, N.Y., 1988. Preferably, the binder is a methylcellulose or ethylcellulose, such as those available from The Dow Chemical Company under the trademarks METHOCEL and ETHOCEL. Preferably, the binder dissolves in the carrier liquid.

The cement composition may also contain one or more porogens. Porogens are materials specifically added to create voids in the dried cement. Typically, these porogens are particulates that decompose, evaporate or in some other way become converted to a gas during a drying or firing step to leave a void. Examples include flour, wood flour, carbon particulates (amorphous or graphitic), nut shell flour or combinations thereof.

The clay mineral may constitute from 10 to 85%, preferably from 15 to 50% and more preferably from 15 to 30% of the weight of the solids in the cement composition. The inorganic filler particles should constitute at least 10%, preferably at least 50% and more preferably at least 70% by weight of the solids of the cement composition. The inorganic filler particles may constitute as much as 90% or as much as 85% of the weight of the solids. For purposes of this calculation, the “solids” are constituted by the inorganic materials in the cement composition, including fillers and inorganic binding phase, that remain in the cement after the cement composition is fired. Carrier fluids, porogens, and organic materials that are lost from the composition during the drying and/or firing step(s) and are no longer present in the dried skin. Therefore, those materials do not constitute any of the solids of the cement composition.

The amount of carrier fluid that is used may vary over a wide range. The total amount of carrier fluid generally is at least about 40% by volume to at most about 90% by volume of the uncured cement composition. The amount of carrier fluid often is selected to provide a workable viscosity to the uncured cement composition. A suitable Brookfield viscosity for the cement composition is at least 15 Pa·s, preferably at least 25 Pa·s, more preferably at least 50 Pa·s at 25° C., as measured using a #6 spindle at a rotational speed of 5 rpm. The Brookfield viscosity under those conditions may be as high as 1000 Pa·s, preferably up to 500 Pa·s, under those conditions.

The amount of porogen, if any, is selected to provide the fired cement layer with a desired porosity. The porosity of the fired cement may vary widely, but it is generally between about 20% to 90%. The porosity may be at least 25%, 30%, 35%, 40%, 45% or 50% to at most about 85%, 80%, 75% or 70%.

The uncured cement composition preferably has a pH of 10 or less, more preferably 9 or less, still more preferably from 2 to 8. At high pH, the clay mineral may become too well dispersed in the carrier fluid and in such a case can more easily permeate into the porous walls of a ceramic honeycomb.

The uncured cement composition is conveniently made using simple mixing methods. The carrier fluid preferably is at a pH of 10 or less, more preferably 9 or less and still more preferably from 2 to 8 at the time it is combined with the clay mineral, to prevent the clay mineral from being too finely dispersed in the carrier fluid.

Honeycomb structures are made using the cement composition by forming a layer of the uncured inorganic cement composition onto at least one surface of a ceramic honeycomb having porous walls. The uncured inorganic cement composition is then fired to form a cured cement layer. The firing step converts part or all of the clay mineral to a binding phase, which adheres the fired cement to the ceramic honeycomb and also binds the inorganic filler particles into the cured cement layer.

The thickness of the applied layer of the uncured cement composition cement layer may be, for example, from about 0.1 mm to about 10 mm.

In some embodiments, the cured cement composition forms a cement layer between segments of a segmented honeycomb structure. In such embodiments, the uncured cement composition is applied to at least one surface of a first honeycomb segment to form a layer. A second honeycomb segment is brought into contact with the layer such that the cement composition is interposed between the first and second honeycomb segment, and the assembly is then fired to convert some or all of the clay mineral to a binding phase that bonds the cement to the honeycomb segments to form the segmented honeycomb structure.

In other embodiments, the cured cement composition forms a peripheral skin on a honeycomb structure, which may be monolithic or segmented. In such a case, the uncured cement composition is applied to the periphery of the honeycomb structure to form a layer, which is then fired to form a ceramic skin. If the honeycomb structure in these embodiments is segmented, an uncured cement composition in accordance with the invention may also be used to bond together the segments of the honeycomb structure.

The ceramic honeycomb is characterized in having axially extending cells defined by intersecting, axially-extending porous walls. The ceramic honeycomb may contain, for example, from about 20 to 300 cells per square inch (about 3 to 46 cells/cm²) of cross-sectional area. The pore size may be, for example, from 1 to 100 microns (μm), preferably from 5 to 50 microns, more typically from about 10 to 50 microns or from 10 to 30 microns. “Pore size” is expressed for purposes of this invention as an apparent volume average pore diameter as measured by mercury porosimetry (which assumes cylindrical pores). The porosity, as measured by immersion methods, may be from about 30% to 85%, preferably from 45% to 70%.

The ceramic honeycomb may be any porous ceramic that can withstand the firing temperature (and use requirements), including, for example, those known in the art for filtering diesel soot. Exemplary ceramics include alumina, zirconia, silicon carbide, silicon nitride and aluminum nitride, silicon oxynitride and silicon carbonitride, mullite, cordierite, beta spodumene, aluminum titanate, strontium aluminum silicates, lithium aluminum silicates. Preferred porous ceramic bodies include silicon carbide, cordierite and mullite or combination thereof. The silicon carbide is preferably one as described in U.S. Pat. No. U.S. 6,669,751B1, EP1142619A1 or WO 2002/070106A1. Other suitable porous bodies are described in U.S. Pat. No. 4,652,286; U.S. Pat. No. 5,322,537; WO 2004/011386A1; WO 2004/011124A1; U.S. 2004/0020359A1 and WO 2003/051488A1.

A mullite honeycomb preferably has an acicular microstructure. Examples of such acicular mullite ceramic porous bodies include those described by U.S. Pat. Nos. 5,194,154; 5,173,349; 5,198,007; 5,098,455; 5,340,516; 6,596,665 and 6,306,335; U.S. Patent Application Publication 2001/0038810; and International PCT publication WO 03/082773.

The firing step typically is performed at a temperature of at least about 600° C., 800° C. or 1000° C. to at most about 1500° C., 1400° C., 1300° C. or 1100° C. The firing step may be preceded by a preliminary heating step at somewhat lower temperatures, during which some or all of the carrier fluid, porogens and/or organic binders are removed. The manner of performing the firing step (and any preliminary heating step, if performed) is not considered to be critical provided that the conditions do not cause the honeycomb(s) to thermally deform or degrade. During the firing step, some or all of the clay mineral forms a binding phase, which may be amorphous, crystalline or partially amorphous and partially crystalline. The clay mineral may undergo a dehydroxylation at a temperature of about 500 to 600° C., and may in addition form a mullite phase at a temperature of 1000° C. or higher.

It has been found that cement compositions as described herein do not permeate into the porous walls of the ceramic honeycombs as much as cement compositions that contain colloidal alumina and/or colloidal silica binders. Because of this reduced permeation, the honeycomb walls adjacent to the cement layer do not become impregnated with the cement to the same extent as when colloidal alumina and/or colloidal binders are instead used as the binder. The porosity of the walls is therefore not reduced as much, and the higher porosity walls do not function as effectively as heat sinks. In addition, there is less permeation of the cement material into the peripheral channels of the honeycomb. The reduced permeation of the cement leads to smaller thermal gradients within the honeycomb structure during its use, and therefore contributes to its thermal shock resistance.

Honeycomb structures of the inventions are useful in a wide range of filtering applications, particularly those involving high temperature operation and/or operation in highly corrosive and/or reactive environments in which organic filters may not be suitable. One use for the filters is in combustion exhaust gas filtration applications, including as a diesel filter and as other vehicular exhaust filters.

Honeycomb structures of the invention are also useful as catalyst supports for use in a wide variety of chemical processes and/or gas treatment processes. In these catalyst support applications, the support carries one or more catalyst materials. The catalyst material may be contained in (or constitute) one or more discriminating layers, and/or may be contained within the pore structure of the walls of the ceramic honeycomb. The catalyst material may be applied to the opposite side of a porous wall to that on which the discriminating layer resides. A catalyst material may be applied onto the support in any convenient method.

The catalyst material may be, for example, any of the types described before. In some embodiments, the catalyst material is a platinum, palladium or other metal catalyst that catalyzes the chemical conversion of NOₓ compounds as are often found in combustion exhaust gases. In some embodiments, a product of this invention is useful as a combined soot filter and catalytic converter, simultaneously removing soot particles and catalyzing the chemical conversion of NOₓ compounds from a combustion exhaust gas stream, such as a diesel engine exhaust stream.

The following examples are provided to illustrate the invention, but are not intended to limit the scope thereof. All parts and percentages are by weight unless otherwise indicated.

### EXAMPLE 1

An uncured cement composition is made by mixing the following components:

| | |
|---|---|
| Ball milled aluminum zirconium silicate fiber (Fibrafrax | 52.0 parts |
| long stable fine fiber, Unifrax LLC) | |
| Ball clay (Todd Dark grade, Kentucky-Tennessee Clay Co.) | 11.0 parts |
| Methyl cellulose (Methocel A15LV, Dow Chemical), | 1.6 parts |
| Water | 33.7 parts |
| Polyethylene glycol 400 (Alfa Aesar) | 1.6 parts |

This ball clay contains 68.4% kaolinite (the clay material) and 31.6% quartz (which together with the fibers constitutes the inorganic filler in this cement composition). After firing at 1100° C., this clay is transformed into 56.5% mullite, 35.8% quartz and 7.7% cristobalite. The fired material has a CTE very close to that of acicular mullite over the temperature range from 0 to 800° C.

The weight ratio of inorganic fillers to clay material in this cement composition is 88.1:11.9.

A portion of the uncured cement composition is coated onto the periphery of a 10 cell×10 cell×7.6 cm acicular mullite honeycomb having 31 cells per square centimeter to form a skin layer. The skin layer is fired at 1100° C. The pressure drop of the honeycomb is measured before and after the skin is applied by passing air through the honeycomb at the rate of 100 standard liters/minute. The addition of the skin layer results in only a 3% increase in pressure drop through the honeycomb.

Another portion of the uncured cement composition is used as a cement layer to form a segmented honeycomb. Nine 7.5×7.5 cm×20.3 cm acicular mullite honeycomb segments (each having 31 cells/square centimeter of cross-sectional area) are assembled with a layer of the uncured cement composition between all seams. The assembly is cut into a cylinder having a diameter of 22.9 cm, and more of the uncured cement composition is applied onto the periphery to form a skin. The assembly is then fired at 1100° C.

The resulting segmented honeycomb is subjected to thermal bench testing as follows. Thermocouples are positioned at the skin and in a channel 10 mm from the skin, at one of the seams, and in one of the channels 10 mm from the thermocouple positioned at the seam. An air flow is established through the segmented honeycomb at a rate of 100 standard cubic feet/minute (4.7 L/s). The air temperature is raised from 290 to 700° C. at a rate of 100° C./minute, held at 700° C. for about three minutes, then reduced to 290° C. at a rate of 100° C./minute and held at that temperature for three minutes to complete cycle. The cycle is repeated at least twice. Temperatures are measured continuously at the two thermocouples during the cycling. The largest temperature difference that is measured between the thermocouples during the temperature cycle is the temperature gradient. The temperature cycling is repeated using an air flow rate of 53 cubic feet/minute (25 L/s). This lower flow rate test is more demanding; it creates higher temperature gradients and generates higher thermal stress in the honeycomb.

Another portion of the uncured cement composition is formed into a layer, fired at 1100° C., and its elastic modulus and modulus of rupture are measured.

Results of the thermal bench testing, elastic modulus and modulus of rupture testing are as indicated in Table 2 below, together with the results of the pressure drop testing.

### EXAMPLE 2 AND COMPARATIVE SAMPLE A

Example 2 and Comparative Sample A are made and tested in the same manner as described in Example 1, except that the uncured cement compositions are made by mixing materials as shown in Table 1 below.

TABLE 1

| | Parts by Weight | |
|---|---|---|
| Ingredient | Ex. 2 | Comp. Sample A |
| Fibers¹ | 45.7 | 42.0 |
| Water | 33.7 | 45.0 |
| Methyl Cellulose | 1.6 | 2.0 |
| Polyethylene glycol² | 1.6 | 2.0 |
| Ball Clay³ | 17.3 | 0 |
| Colloidal Alumina⁴ | 0 | 13.5 |
| Inorganic Filler/Clay material ratio⁵ | 81.2:18.8 | 75.7:24.3 |

¹Ball milled aluminum zirconium fibers (Fiberfrax Long Staple Fine Fiber, Unifrax LLC).
²Polyethylene glycol 400 (Alfa Aesar).
³Todd Dark grade (Kentucky-Tennessee Clay Co.)
⁴AL20SD (Nyacol Nano Technologies Inc.).
⁵For Example 2, the inorganic fillers include the fibers and the quartz component of the ball clay. Comp. Sample A, fiber/colloidal alumina ratio.

Results of the testing are as indicated in Table 2.

TABLE 2

| Property | Ex. 1 | Ex. 2 | Comp. Sample A |
|---|---|---|---|
| Binder | Kaolinite | Kaolinite | Colloidal Alumina |
| Inorganic Filler/Mineral | 88.1:11.9 | 81.2:18.8 | 75.7:24.3 |
| Clay ratio¹ | | | |
| Pressure drop increase² | 3% | <0.5% | 13% |
| Temperature Gradient, | 80 | 75 | 139 |
| 47 L/s air flow³ | | | |
| Temperature Gradient, | 98 | 98 | 176 |
| 25 L/s air flow³ | | | |
| Elastic Modulus, GPa | 2.0 | 7.1 | 2.6 |
| Modulus of Rupture, MPa | 1.6 | 5.5 | 2.1 |

¹For Examples 1 and 2, the inorganic fillers include the fibers and the quartz component of the ball clay. Comp. Sample A, fiber/colloidal alumina ratio.
²Increase of pressure drop of the skinned honeycomb relative to that of the unskinned honeycomb.
³Temperature difference between the skin and a channel 10 mm from the skin.

The data in Table 2 shows that the cured cements of the invention lead to much smaller increases in pressure drop through the filters, when compared to Comparative Sample A. These results suggest that less of the binder permeates into the adjacent porous walls of the honeycomb in Examples 1 and 2. The honeycomb structures of the invention also exhibit greatly reduced temperature gradients, which is indicative of higher thermal shock resistance. Modulus of rupture and elastic modulus are lower for Example 1 than for Comparative Sample A, but this is believed to be due to the much lower proportion of binder in the Example 1 cement composition. The Example 2 cement composition, which has a larger proportion of binder, has a modulus of rupture and an elastic modulus more than double that of Comparative Sample A.

The fired Example 2 composition has a CTE very close to that of acicular mullite over the temperature range from 0 to 800° C.

### EXAMPLE 3

An uncured cement composition is made by mixing the following components:

| | |
|---|---|
| Ball milled aluminum zirconium silicate fiber (Fibrafrax | 47.3 parts |
| long stable fine fiber, Unifrax LLC) | |
| Ball clay (Todd Dark grade, Kentucky-Tennessee Clay Co.) | 15.8 parts |
| Methyl cellulose (Methocel A15LV, Dow Chemical), | 1.6 parts |
| Water | 33.7 parts |
| Polyethylene glycol 400 (Alfa Aesar) | 1.6 parts |

The weight ratio of inorganic fillers to clay mineral in this composition is 82.9:17.1. After firing at 1100° C., the elastic modulus is 6.0 GPa and modulus of rupture of this cement is 4.3 MPa.

### EXAMPLE 4

An uncured cement composition having the same composition as Example 1 is fired at 1400′C. The elastic modulus is 6.6 GPa and modulus of rupture is 4.9 MPa.

### EXAMPLE 5

An uncured cement composition having the same composition as Example 2 is fired at 1400′C. The elastic modulus is 11.9 GPa and modulus of rupture is 7.4 MPa.

1. A method of forming a honeycomb structure comprising forming a layer of an uncured inorganic cement composition on at least one surface of a ceramic honeycomb having porous walls and then firing the uncured inorganic cement composition and the ceramic honeycomb to form a cured cement layer on said at least one surface of the ceramic honeycomb,
wherein the uncured inorganic cement composition contains particles of at least one inorganic filler, at least one carrier fluid and an inorganic binder, and further wherein at least 75% by weight of the inorganic binder is a clay mineral and wherein colloidal alumina and colloidal silica together constitute from 0 to 25% of the weight of the inorganic binder.

2. The method of claim 1, wherein colloidal alumina and colloidal silica together constitute from 0 to 10% of the weight of the organic binder.

3. The method of claim 1, wherein colloidal alumina and colloidal silica together constitute from 0 to 2% of the weight of the organic binder.

4. The method of claim 1, wherein the clay mineral constitutes from 15 to 50% of the weight of the solids in the uncured inorganic cement composition and the inorganic filler particles constitute from 50 to 85% weight of the solids of the uncured inorganic cement composition.

5. The method of claim 1 wherein the clay mineral is a clay mineral of the kaolin-serpentine group.

6. The method of claim 1 wherein the clay mineral is provided as kaolin or ball clay.

7. The method of claim 1 wherein the uncured cement composition has a pH from 2 to 8.

8. The method of claim 1 wherein the uncured cement composition is made by mixing the inorganic filler particles and clay mineral with a carrier fluid, and the carrier fluid has a pH of 2 to 8 at the time it is mixed with the clay mineral.

9. The method of claim 1 wherein the honeycomb structure is segmented and the cement layer is an adhesive layer between segments of the segmented honeycomb structure.

10. The method of claim 1 wherein the cement layer is a skin layer on the ceramic honeycomb.
